(19) United States
(12) Patent Application Publication
(10) Pub. No.: US 2014/0078737 A1
(43) Pub. Date: Mar. 20, 2014

(54) ACTIVE HEAT DISSIPATING LIGHT EMITTING DIODE ILLUMINATION LAMP

(71) Applicants: KUO-JEN LIN, NEW TAIPEI CITY (TW); CHIH-HUNG CHENG, NEW TAIPEI CITY (TW); WEN-JUNG LIU, NEW TAIPEI CITY (TW)

(72) Inventors: KUO-JEN LIN, NEW TAIPEI CITY (TW); CHIH-HUNG CHENG, NEW TAIPEI CITY (TW); WEN-JUNG LIU, NEW TAIPEI CITY (TW)

(21) Appl. No.: 13/721,044

(22) Filed: Dec. 20, 2012

(30) Foreign Application Priority Data
Sep. 18, 2012 (TW) 101134108

(51) Int. Cl. F21V 29/00

(52) U.S. Cl. CPC F21V 29/2206
USPC 362/249.02

(57) ABSTRACT

An active heat dissipating LED illumination lamp includes a substrate holder, at least one LED illumination assembly, a plurality of heat pipes and a heat sink module. The LED illumination assembly is installed on a side of the substrate holder, and the heat pipes and the heat sink module are installed on the other side of the substrate holder, and a plurality of first diversion channels is formed between the heat pipes, and each heat dissipating fin has at least one ventilation hole occupying 12%˜60% of the total area to form a second diversion channel, and a second interval is defined between the bottom of the heat sink module and the substrate holder. When the heat generated by the LED illumination assembly is provided for performing heat conduction, the heat is guided actively to the second diversion channel to perform heat convection.

### CROSS-REFERENCE TO RELATED APPLICATIONS

This non-provisional application claims priority under 35 U.S.C. §119(a) on Patent Application No(s). 101134108 filed in Taiwan, R.O.C. on Sep. 18, 2012, the entire contents of which are hereby incorporated by reference.

### BACKGROUND OF THE INVENTION

1. Field of the Invention

The present invention relates to the technical field of LED illumination lamps, and more particularly to an active heat dissipating LED illumination lamp structure that uses the method of producing heat convection by using heat conduction to dissipate the heat generated during the illumination of the lamp.

2. Description of the Related Art

In recent years, the development of light emitting diodes (LED) is closely related to the illumination industry closely. Since the LED features the advantages of high efficiency, power saving, long life, cold luminescence, quick response rate, and highly consistent color, therefore the LED has gradually replaced traditional light sources for the purpose of illumination applications. The life and illumination function of the LED are closely related to the heat dissipation efficiency. As LED illumination lamps are developed to be used for increasingly higher power applications such as the intensive LED lamps including embedded lights and patio lights, a substantial amount of heat energy is accumulated during use, and thus the life and light emission performance of the lamp are reduced significantly.

In the past, the power applied in the high power LED illumination lamps generally fell within a range of 70 W˜260 W, and an LED circuit substrate was installed on a heat conductor which is a cylindrical or block structure made of a thermally conductive material such as aluminum alloy or copper alloy, and the exterior of the heat conductor has a plurality of fins integrally formed or attached by other method for conducting heat to the fins. Since the high power illumination lamps generates a large amount of heat, therefore a heat dissipation fan is generally installed for blowing an airflow to the fins by a compulsory air intake method, so as to effectively and quickly eliminate the heat energy generated by the high power LED illumination lamp and assure the stable application and popular promotion of the high power LED illumination lamp, as well as the function and life of the LED circuit substrate. In addition, there are related designs using a heat pipe or a vapor chamber for the heat dissipation.

Although the high power LED illumination lamp with the aforementioned heat dissipating structure has good heat conduction and dissipation effects, yet the lamp comes with a large volume and requires additional power supply for the fan, so that it is difficult to promote and apply such heat dissipating structure for a long time use of the high power LED illumination lamp such as the embedded lights or the patio lights.

### SUMMARY OF THE INVENTION

In view of the problems of the prior art, it is a primary objective of the present invention to overcome the problems of the prior art by providing an active heat dissipating LED illumination lamp, comprising: a substrate holder, having an installation surface;

at least one Light emitting diode illumination assembly, installed on the installation surface, and provided for conducting the heat of the Light emitting diode illumination assembly to the substrate holder; a plurality of heat pipes, extended in a direction opposite to the installation surface and installed on the substrate holder; and a heat sink module, having a plurality of heat dissipating fins separated from on another with a first interval and disposed on the heat pipes and stacked from bottom up on the top of the substrate holder to form a plurality of first diversion channels, and each of the heat dissipating fins having at least one ventilation hole, and each ventilation hole having an area equal to 12%˜60% of the area of each heat dissipating fin to form a second diversion channel arranged from the bottom up, so that heat generated by the Light emitting diode illumination assembly is conducted to the substrate holder and the heat pipes, and dissipated quickly upward from the second diversion channel; wherein a second interval is formed between the heat sink module bottom and the substrate holder for guiding the heat to the second diversion channel.

Wherein, the first interval falls within a range of 4.0 mm˜12.0 mm, and each first diversion channel can dissipate some of the heat.

In a preferred embodiment, the substrate holder has a plurality of grooves formed on a side of the substrate holder, and each groove has at least one heat pipe installed therein, and the heat pipe has an external surface being a planar surface for attaching onto the at least one Light emitting diode illumination assembly. For example, the heat pipes are arranged side by side with one another in the groove when the plurality of heat pipes is installed in the same groove.

In another preferred embodiment, the substrate holder includes a seat body and a cover plate, and the seat body has a plurality of grooves formed on a side of the seat body, and each groove has at least one heat pipe installed therein, and the cover plate is covered and sealed onto the grooves. For example, the heat pipes are arranged side by side with one another in the groove, when the plurality of heat pipes is installed in the same groove.

In addition, the second diversion channel varies with a different design of the ventilation hole of each of the heat dissipating fins. For example, if the area the ventilation hole of each of the heat dissipating fins is equal to the area of other ventilation holes, the second diversion channel is arranged in a column form, or the area of the ventilation hole of each of the heat dissipating fins can be tapered upwardly or downwardly.

In addition, a fixed board is installed on at least one side of the heat dissipating fins and provided for sealing and fixing the first interval of the heat dissipating fins, so that at least one side of the heat dissipating fins is sealed.

In another preferred embodiment, the heat dissipating fin has the heat pipes installed thereon and opposite to one another, and the at least one ventilation hole is disposed between adjacent heat pipes; or the at least one ventilation hole is disposed on an external side of the heat pipes, so that the second diversion channel is formed between each pair of heat pipes or on the external side of the heat pipes for dissipating heat outwardly from the second diversion channel.

In the active heat dissipating LED present invention, the illumination lamp is mainly used for the purpose of high power illumination of 70 W˜260 W. When use, the heat pipes are in a direct contact with the substrate holder, and the light emitting diode illumination assembly is installed on the installation surface of the substrate holder which is commonly used in the Heat-pipe Direct Touch (HDT) technology for central processing units (CPU) to conduct heat to the heat pipes directly and effectively, and then the heat dissipating fms of the heat sink module are stacked with an interval apart on the heat pipes to form the second diversion channel between the heat pipes or on the external side of the heat pipes. When the heat is circulated between the heat pipes and the heat sink module, the heat also drives the hot airflow to dissipate outwardly towards the second diversion channel at the same time, so as to achieve the effect of dissipating the heat quickly and effectively without requiring any external force. Experiments show that the present invention can reduce the temperature by 5˜10° C. during use.

### BRIEF DESCRIPTION OF THE DRAWINGS

FIG. 1 is a schematic view of a first preferred embodiment of the present invention;

FIG. 2 is a first side view of an assembled LED illumination lamp in accordance with the first preferred embodiment of the present invention;

FIG. 3 is a second side view of an assembled LED illumination lamp in accordance with the first preferred embodiment of the present invention;

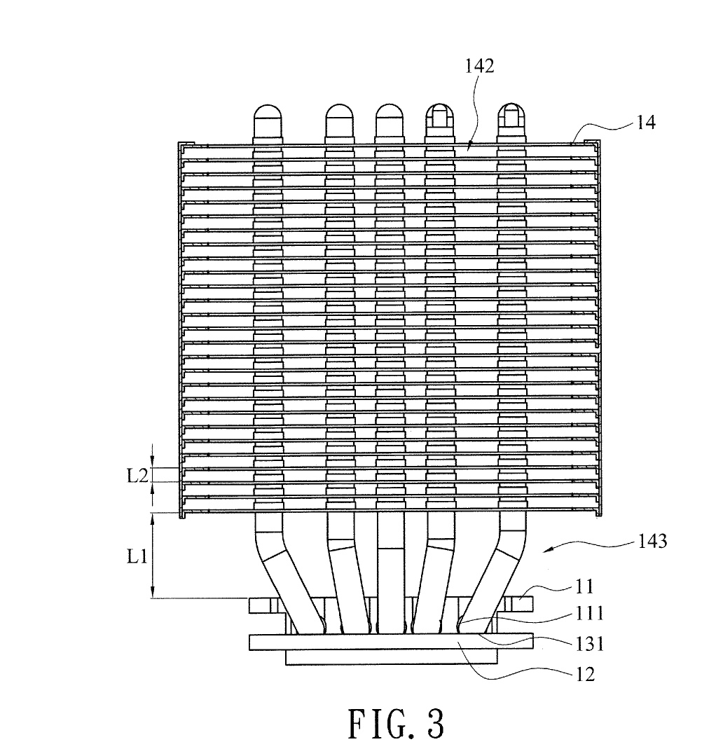

FIG. 4 is a top view of an assembled LED illumination lamp in accordance with the first preferred embodiment of the present invention;

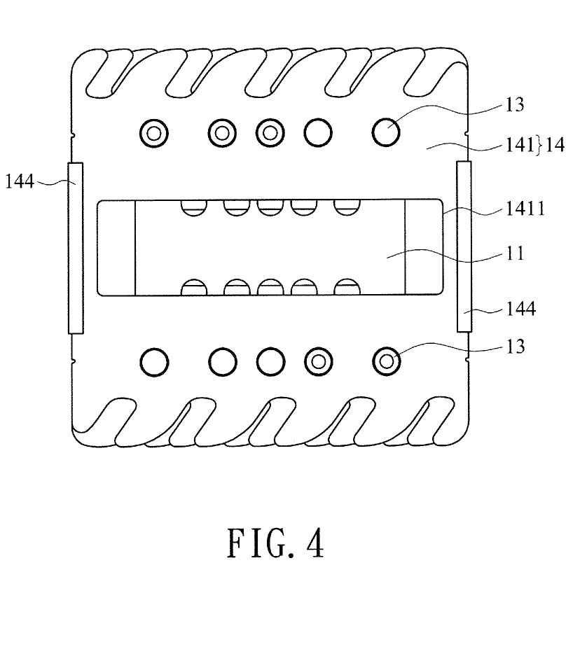

FIG. 5 is a schematic view of another enablement mode in accordance with the first preferred embodiment of the present invention;

FIG. 6 is a schematic view of a further enablement mode in accordance with the first preferred embodiment of the present invention;

FIG. 7 is a schematic view of a using status of the first preferred embodiment of the present invention;

FIG. 8 is another enablement mode of the first preferred embodiment of the present invention;

FIG. 9 is a schematic view of a second preferred embodiment of the present invention; and

FIG. 10 is a perspective view of an assembled LED illumination lamp in accordance with the second preferred embodiment of the present invention.

### DETAILED DESCRIPTION OF THE PREFERRED EMBODIMENTS

The technical contents of the present invention will become apparent with the detailed description of preferred embodiments and the illustration of related drawings as follows.

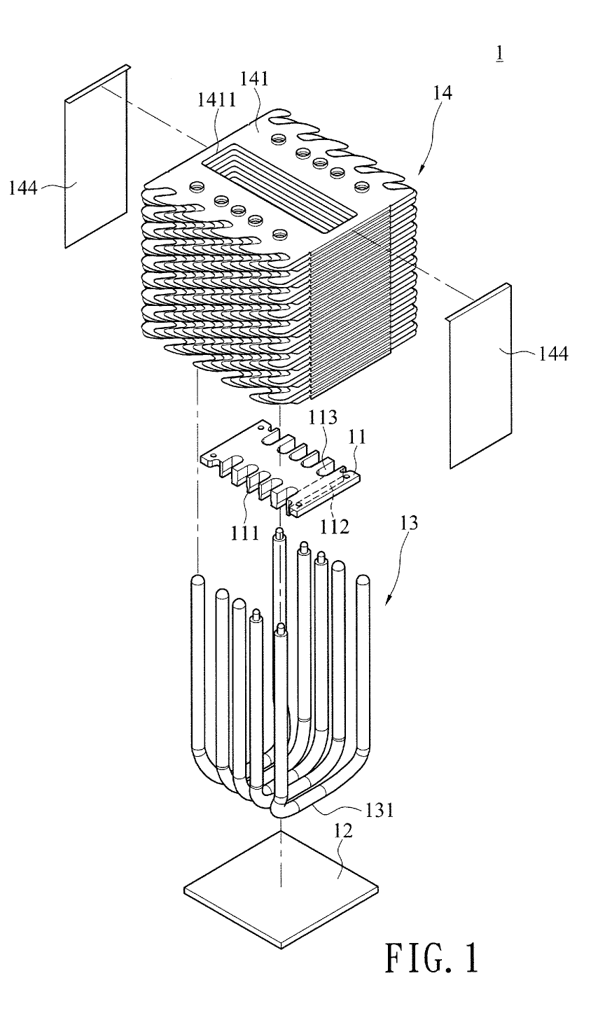

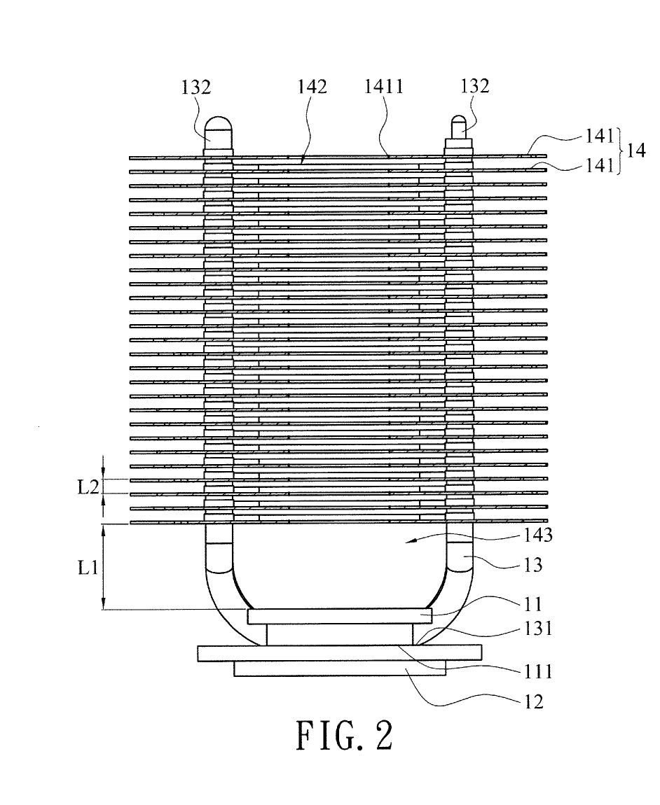

With reference to FIGS. 1, 2˜4, and 5˜7 for a schematic view, various side views, and other schematic views of the assembled structure in accordance with the first preferred embodiment of the present invention respectively, the active heat dissipating LED illumination lamp 1 of the present invention comprises a substrate holder 11, an Light emitting diode illumination assembly 12, a plurality of heat pipes 13 and a heat sink module 14, and the active LED illumination lamp 1 is mainly used for high power illuminations of 70 W˜260 W.

Wherein, the substrate holder 11 is a rectangular block structure made of a thermally conductive metal material, and the substrate holder 11 has an installation surface 111, a plurality of grooves 112 formed on the installation surface 111, and both ends of each groove 112 have a notch 113 separately interconnected to both surfaces of the substrate holder 11.

The heat pipe 13 is substantially an U-shaped tube structure having a condensing end 131 formed separately at both ends of the heat pipe 13 and an evaporating end 132 formed at the middle of the heat pipe 13, and the pair of condensing ends 131 of each heat pipe 13 are passed into the pair of notches 113 of each groove 112 respectively, and the evaporating end 132 of the heat pipe 13 is disposed in each groove 112, and the pair of condensing ends 131 are extended in a direction opposite to the installation surface 111 and disposed on the substrate holder 11. In addition, the external surface of the evaporating end 132 of the heat pipes 13 and the installation surface 111 jointly form a planar surface. It is noteworthy that a single heat pipe 13 can be installed in a groove 112 or a plurality of heat pipes 13 can be installed in the same groove 112 and arranged side by side with one another in the same groove 112. The first preferred embodiment of the present invention as shown in the figure is provided for the purpose of illustrating the present invention, but not intended for limiting the scope of the invention.

The Light emitting diode illumination assembly 12 is attached onto the installation surface 111, so that the heat generated by the Light emitting diode illumination assembly 12 can be conducted to the substrate holder 11 and the heat pipes 13.

The heat sink module 14 has a plurality of heat dissipating fins 141, and each of the heat dissipating fins 141 is a rectangular plate structure, and each of the heat dissipating fins 141 is disposed on the heat pipes 13 and with a first interval L1 apart from the other adjacent fin, and the first interval L1 falls within a range of 4.0 mm˜12.0 mm, preferably 8.0 mm, so that the heat dissipating fins 141 are stacked parallelly bottom up at the top of the substrate holder 11, and a plurality of first diversion channels 142 is formed between adjacent heat dissipating fins 141, and each first diversion channel 142 can dissipate some of the heat; and a ventilation hole 1411 is formed at the middle of each of the heat dissipating fins 141, and the area of each ventilation hole 1411 occupies 12%˜60% of the area of each of the heat dissipating fins 141, and the ventilation holes 1411 form a second diversion channel 143 from bottom to top. It is noteworthy that it is necessary to reserve a second interval L2 between the bottom of the heat sink module 14 of the present invention and the substrate holder 11 for guiding the heat to the second diversion channel 143. In addition, the heat sink module 14 has a fixed board 144 installed on at least one side of the heat sink module 14 for covering at least one side of the heat sink module 14. In the figure, two fixed boards 144 are installed on two symmetrical sides of the heat sink module 14 respectively.

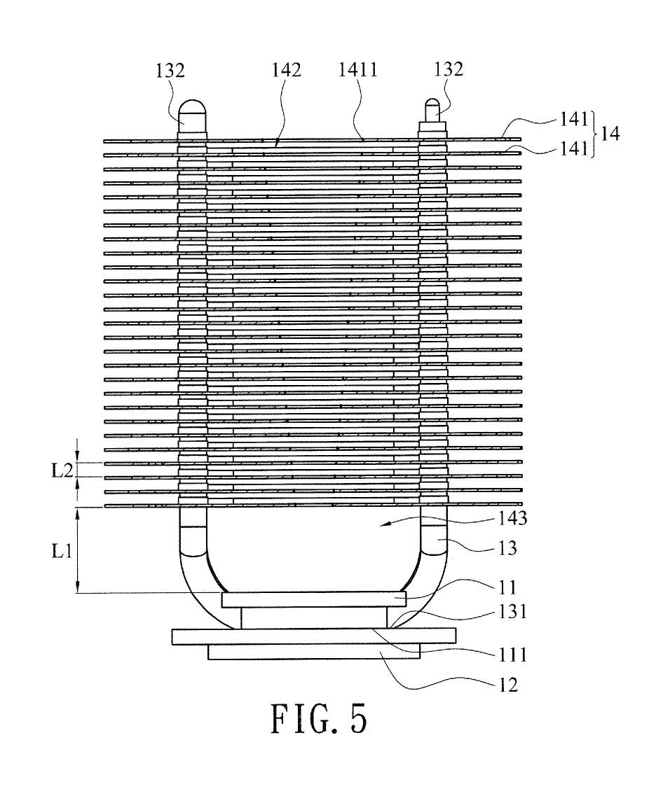

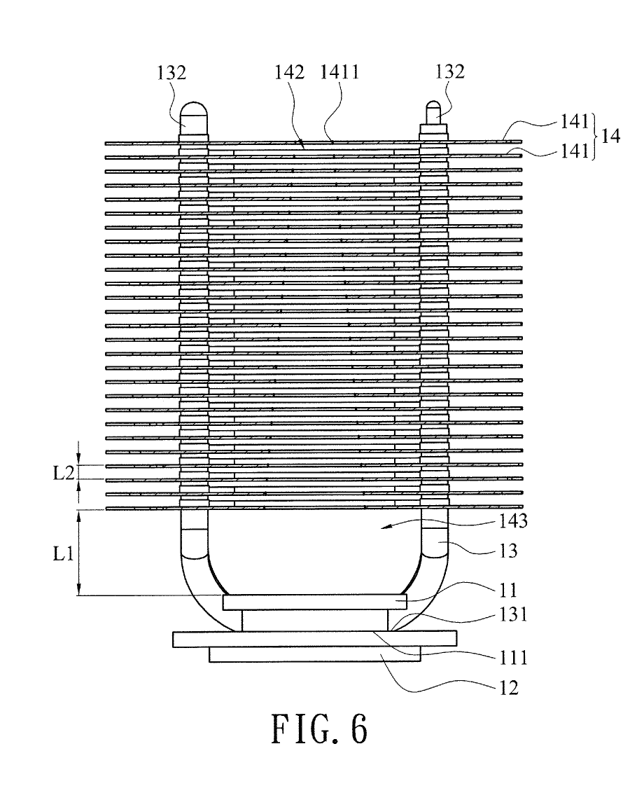

In addition, the heat pipes 13 opposite to each other are installed on each of the heat dissipating fins 141 of the assembled structure of the present invention, and the ventilation hole 1411 is disposed between the opposite heat pipes 13, and the shape of the ventilation hole 1411 of each of the heat dissipating fins 141 will affect the shape of the second diversion channel 143 and result in a different effect of the application. In FIG. 2, if the ventilation hole 1411 of each of the heat dissipating fins 141 has the same area, the second diversion channel 143 is in the form of a column perpendicular to the substrate holder 11. In FIG. 5, if the area of the ventilation hole 1411 of each of the heat dissipating fins 141 is tapered upwardly (in other words, the area of the ventilation hole 1411 of the heat dissipating fin 141 at the bottom is greater than the area of the ventilation hole 1411 at the middle of the heat dissipating fin 141, and also greater than the area of the ventilation hole 1411 of the heat dissipating fin 141 at the top, so that the second diversion channel 143 is in a pyramidal form. In FIG. 6, if the area of the ventilation hole 141 of each of the heat dissipating fins 141 is tapered downwardly (in other words, the area of the ventilation hole 1411 of the heat dissipating fin 141 at the top is greater than the area of the ventilation hole 1411 at the middle of the heat dissipating fin 141 and also greater than the area of the ventilation hole 1411 of the heat dissipating fin 141 at the bottom, so that the second diversion channel 143 is in an inverted pyramidal form.

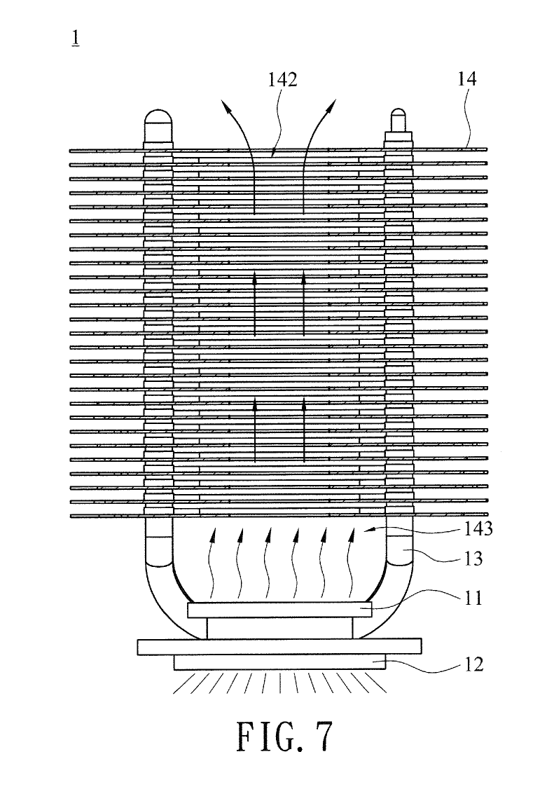

In FIG. 7, when the present invention is in use, the Light emitting diode illumination assembly 12 is turned on, and the heat generated by the Light emitting diode illumination assembly 12 is conducted to the substrate holder 11 and the heat pipes 13 directly, and some of the heat rises upward from the top of the substrate holder 11, and the second diversion channel 143 is provided for guiding the heat upward to the top of the heat sink module 14, and some of the heat is conducted to the heat sink module 14 through the heat pipes 13 and dissipated by the first diversion channels 142. Therefore, the present invention can dissipate the heat actively without requiring an additional fan. Of course, external wind can be added to improve the heat dissipation efficiency effectively.

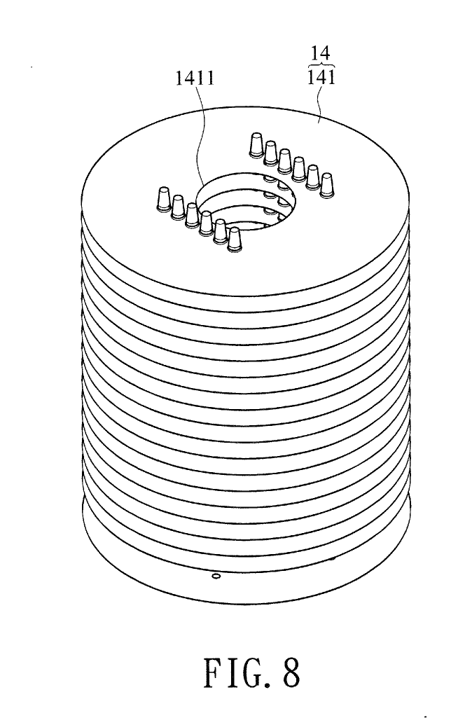

With reference to FIG. 8 for another enablement mode of the first preferred embodiment of the present invention, each of the heat dissipating fins 141 of the heat sink module 14 is in a circular shape, and arranged to form a cylindrical structure, and the ventilation hole 1411 of each of the heat dissipating fins 141 is disposed at the center position of each heat dissipating fin 141.

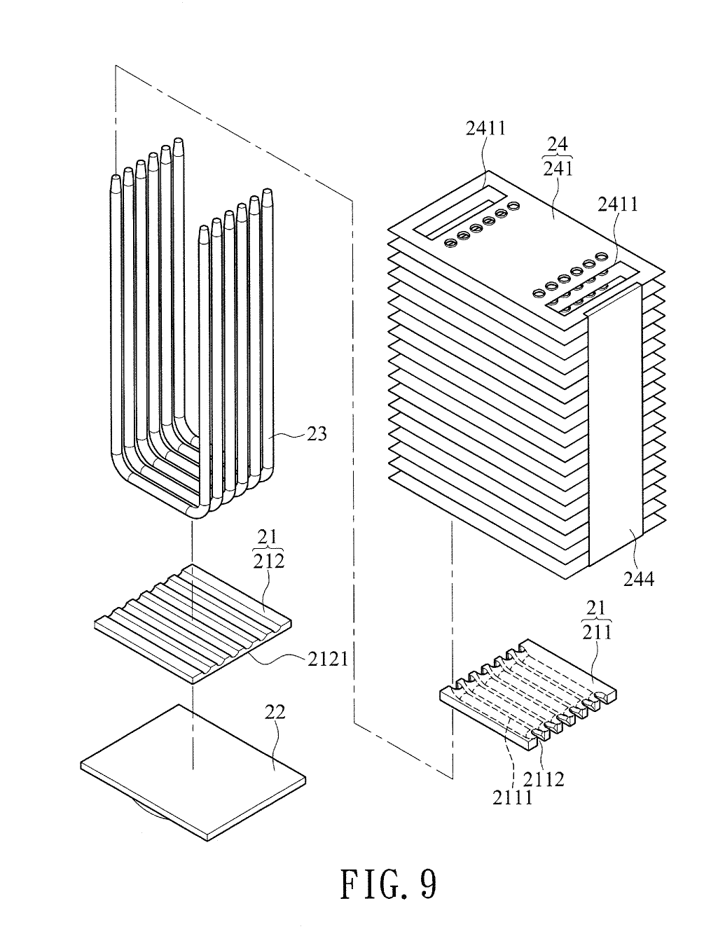

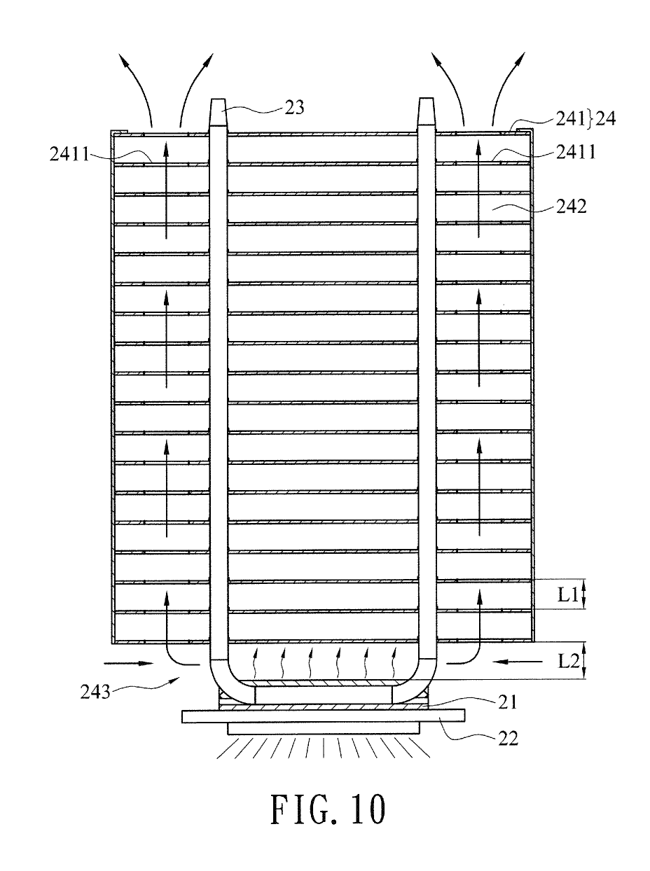

With reference to FIGS. 9 and 10 for a schematic view and a perspective view of the second preferred embodiment of the present invention, the active heat dissipating LED illumination lamp 2 of this embodiment comprises a substrate holder 21, a light emitting diode illumination assembly 22, a plurality of heat pipes 23 and a heat sink module 24.

Wherein, the substrate holder 21 includes a seat body 211 and a cover plate 212, and a plurality of grooves 2111 is formed on a side of the seat body 211, and a notch 2112 is foimed separately at both ends of each groove 2111 for passing the at least one heat pipe 23 into each groove 2111, and the cover plate 212 is covered and sealed onto the grooves 2111, so that an installation surface 2121 is formed at the exterior of the cover plate 212.

The Light emitting diode illumination assembly 22 is arranged onto the installation surface 2121 by integrated package or chip on board (COB) method.

The heat sink module 24 also has a plurality of heat dissipating fins 241, and the heat dissipating fins 241 are stacked with the first interval L1 apart from one another and disposed on the heat pipes 23, and a first diversion channel 242 is formed between adjacent heat dissipating fins 241. In addition, a fixed board 244 is installed separately on two sides of the heat sink module 24 and provided for sealing and fixing the first interval L1 of the heat dissipating fins 241. However, this preferred embodiment is provided for the purpose of illustrating the present invention, but not intended for limiting the scope of the invention. In fact, the fixed board(s) 244 can be installed on one to four sides of the heat sink module 24 in the present invention to achieve the same effect of sealing and fixing the first interval L1.

In the second preferred embodiment, the opposite heat pipes 23 are installed on each of the heat dissipating fins 241 of the heat sink module 24, and each of the heat dissipating fins 241 has a pair of ventilation holes 2411 formed thereon, and the pair of ventilation holes 2411 are disposed on external sides of the heat pipes 23 respectively to form a pair of second diversion channels 243. Similarly, it is necessary to reserve a second interval L2 between the bottom of the heat sink module 24 and the substrate holder 21 for guiding the heat to the pair of second diversion channels 243 successfully and dissipating the heat upwardly and quickly. The application of this preferred embodiment is the same as that of the previous preferred embodiment, and thus will not be repeated.

What is claimed is:

1. An active heat dissipating LED illumination lamp, capable of providing an application of a high power illumination of 70 W˜260 W, comprising:
a substrate holder, having an installation surface;
at least one Light emitting diode illumination assembly, installed on the installation surface, and provided for conducting the heat of the Light emitting diode illumination assembly to the substrate holder;
a plurality of heat pipes, extended in a direction opposite to the installation surface and installed on the substrate holder; and
a heat sink module, having a plurality of heat dissipating fins separated from on another with a first interval and disposed on the heat pipes and stacked from bottom up on the top of the substrate holder to form a plurality of first diversion channels, and each of the heat dissipating fins having at least one ventilation hole, and each ventilation hole having an area equal to 12%˜60% of the area of each heat dissipating fin to form a second diversion channel arranged from the bottom up, so that heat generated by the Light emitting diode illumination assembly is conducted to the substrate holder and the heat pipes, and dissipated quickly upward from the second diversion channel;
wherein a second interval is formed between the heat sink module bottom and the substrate holder for guiding the heat to the second diversion channel.

2. The active heat dissipating LED illumination lamp of claim 1, wherein the substrate holder has a plurality of grooves formed on a side of the substrate holder, and each groove has at least one heat pipe installed therein, and the heat pipe has an external surface being a planar surface for attaching onto the at least one Light emitting diode illumination assembly.

3. The active heat dissipating LED illumination lamp of claim 2, wherein the heat pipes in the same groove are arranged side by side with one another.

4. The active heat dissipating LED illumination lamp of claim 1, wherein the substrate holder includes a seat body and a cover plate, and the seat body has a plurality of grooves formed on a side of the seat body, and each groove has at least one heat pipe installed therein, and the cover plate is covered and sealed onto the grooves.

5. The active heat dissipating LED illumination lamp of claim 4, wherein the heat pipes in the same groove are arranged side by side with one another.

6. The active heat dissipating LED illumination lamp of claim 1, wherein the first interval falls within a range of 4.0 mm˜12.0 mm.

7. The active heat dissipating LED illumination lamp of claim 1, wherein each first diversion channel is provided for dissipating some of the heat.

8. The active heat dissipating LED illumination lamp of claim 1, wherein the ventilation hole of each of the heat dissipating fins has the same area.

9. The active heat dissipating LED illumination lamp of claim 1, wherein the ventilation hole of each of the heat dissipating fins has an area which is tapered upwardly.

10. The active heat dissipating LED illumination lamp of claim 1, wherein the ventilation hole of each of the heat dissipating fins has an area which is tapered downwardly.

11. The active heat dissipating LED illumination lamp of claim 1, further comprising a fixed board disposed on at least one side of the heat dissipating fins and provided for sealing and fixing the first interval of the heat dissipating fins.

12. The active heat dissipating LED illumination lamp of claim 1, wherein the heat dissipating fins have the heat pipes installed thereon and opposite to each other, and the at least one ventilation hole is disposed between the opposite heat pipes.

13. The active heat dissipating LED illumination lamp of claim 1, wherein the heat dissipating fins have the heat pipes installed thereon and opposite to each other, and the at least one ventilation hole is disposed on an external side of the heat pipes.
